(19) United States
(12) Patent Application Publication
(10) Pub. No.: US 2026/0122898 A1
(43) Pub. Date: Apr. 30, 2026

(54) NON-VOLATILE MEMORY DEVICE AND METHOD OF FABRICATING NON-VOLATILE MEMORY CELL

(71) Applicant: eMemory Technology Inc., Hsinchu (TW)

(72) Inventors: Cheng-Yen SHEN, Hsinchu County (TW); Chia-Jung HSU, Hsinchu County (TW); Tsung-Mu LAI, Hsinchu County (TW)

(21) Appl. No.: 19/004,492

(22) Filed: Dec. 30, 2024

Related U.S. Application Data
(60) Provisional application No. 63/620,725, filed on Jan. 12, 2024.

(51) Int. Cl. H10B 43/35; G11C 16/04; G11C 16/14; G11C 16/34; H10B 43/10; H10D 30/69; H10D 64/01

(52) U.S. Cl. CPC H10B 43/35; G11C 16/0475; G11C 16/14; G11C 16/3427; H10B 43/10; H10D 30/696; H10D 64/037

(57) ABSTRACT

A non-volatile memory device includes a plurality of non-volatile memory cell, a body oxide layer, and a well layer above the body oxide layer and has a doped type of a first type. Each non-volatile memory cell includes first to third doped regions within the well layer, a select gate structure and a memory gate structure. The third doped region includes a first portion and a second portion. The select gate structure is formed above the well layer and between the first and second doped regions. The memory gate structure is formed above the well layer and between the second and third doped regions. The first portion of the third doped region has a doped type of the first type, and the first and second doped regions and the second portion of the third doped region have a doped type of a second type different from the first type.

### RELATED APPLICATIONS

This application claims priority to U.S. Provisional Application Ser. No. 63/620,725, filed Jan. 12, 2024, which is herein incorporated by reference in its entirety.

### BACKGROUND

### Technical Field

The present disclosure is related to non-volatile memory devices and the method of fabricating non-volatile memory cells. More particularly, the present disclosure is related to non-volatile memory devices with a butted contact structure and the method of fabricating non-volatile memory cells.

### Description of Related Art

Memory devices are one of the indispensable components in many electronic products today. Among these memory devices, non-volatile memory devices are widely used because they retain stored data after the power is turned off.

However, since today's electronic products become increasingly smaller in size, how to reduce the size of the memory device has become a new challenge. In addition, the reduction in the size of semiconductor components will also intensify the impact of the band-to-band tunneling (BTBT) effect, thereby making the memory device prone to misjudgment and affecting its performance. Therefore, how to effectively reduce the size of memory devices while alleviating the impact of the BTBT effect is one of the topics in this field.

### SUMMARY

A non-volatile memory device is provided in the present disclosure. The non-volatile memory device comprises a plurality of non-volatile memory cells, a body oxide layer and a well layer, wherein the well layer is above the body oxide layer and has a doped type of a first type. Each of the non-volatile memory cells comprises a first doped region, a second doped region, a third doped region, a select gate structure and a memory gate structure. The third doped region comprises a first portion and a second portion. The first doped region, the second doped region and the third doped region are formed within the well layer. The select gate structure is formed above the well layer and is located between the first doped region and the second doped region. The memory gate structure is formed above the well layer and is located between the second doped region and the third doped region. The first portion of the third doped region has a doped type of the first type, and the first doped region, the second doped region and the second portion of the third doped region have a doped type of a second type, wherein the first type is different from the second type.

A method of fabricating each memory cell of a plurality of non-volatile memory cells of a non-volatile memory device is provided in the present disclosure. The method comprises: forming a well layer above a body oxide layer, wherein the well layer has a doped type of a first type; forming a select gate structure above the well layer; forming a memory gate structure above the well layer; forming a first doped region, a second doped region and a third doped region within the well layer, wherein the select gate structure is located between the first doped region and the second doped region, and the memory gate structure is located between the second doped region and the third doped region; and forming a first portion and a second portion of the third doped region, wherein the first portion of the third doped region has a doped type of the first type, and the first doped region, the second doped region and the second portion of the third doped region have a doped type of a second type, wherein the first type is different from the second type.

The non-volatile memory device and the method of fabricating non-volatile memory cells as described in the present disclosure can not only reduce the size of memory devices and alleviate the impact of the BTBT effect by using a programming method of reverse programming, but also enhance the efficiency of erasing operations by adding a butted contact structure in memory cells.

It should be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1 is a top view of non-volatile memory cells in accordance with some instances.

FIG. 2 is a top view of a non-volatile memory device comprising non-volatile memory cells in accordance with some embodiments of the present disclosure.

FIG. 3 is a top view of a non-volatile memory device comprising non-volatile memory cells in accordance with some embodiments of the present disclosure.

FIG. 4A is a cross-sectional view of a non-volatile memory cell based on the cross-section line X1-X1′ of FIG. 3.

FIG. 4B is a cross-sectional view of a non-volatile memory cell based on the cross-section line X2-X2′ of FIG. 3.

FIG. 5 is a cross-sectional view of a non-volatile memory cell in accordance with some embodiments of the present disclosure.

FIG. 6A is a schematic diagram of voltage configuration of non-volatile memory cells in accordance with some instances.

FIG. 6B is a schematic diagram of voltage configuration of non-volatile memory cells in accordance with some embodiments of the present disclosure.

FIG. 7A is a part of a flowchart of a method of fabricating a non-volatile memory cell in accordance with some embodiments of the present disclosure.

FIG. 7B is a part of a flowchart of a method of fabricating a non-volatile memory cell in accordance with some embodiments of the present disclosure.

### DETAILED DESCRIPTION

Reference will now be made in detail to the present embodiments of the disclosure, examples of which are illustrated in the accompanying drawings.

In the present disclosure, when an element is referred to as “connected”, it may mean “electrically connected” or “optical connected”. When an element is referred to as “coupled”, it may mean “electrically coupled” or “optical coupled”. “Connected” or “coupled” can also be used to indicate that two or more components operate or interact with each other. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

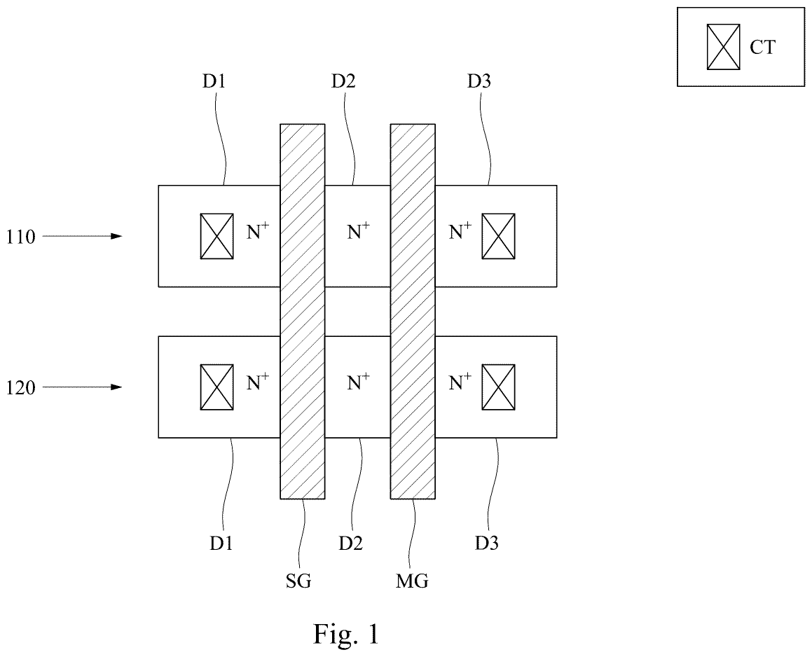

FIG. 1 is a top view of non-volatile memory cells 110 and 120 in accordance with some instances. Each of the non-volatile memory cells 110 and 120 comprises doped regions D1-D3 located in a well layer (not shown), and a select gate structure and a memory gate structure located above the well layer. The select gate structure is represented by the topmost layer thereof, that is, the select gate SG. The memory gate structure is represented by the topmost layer thereof, that is, the memory gate MG. Each of the doped regions D1 and D3 is coupled to a contact CT. The doped regions D1-D3 have a doped type of the same type, such as N-type (marked with symbol “N+”) or P-type (marked with symbol “P+”). In addition, the non-volatile memory cells 110 and 120 share the select gate structure (e.g., the select gate SG) and the memory gate structure (e.g., the memory gate MG).

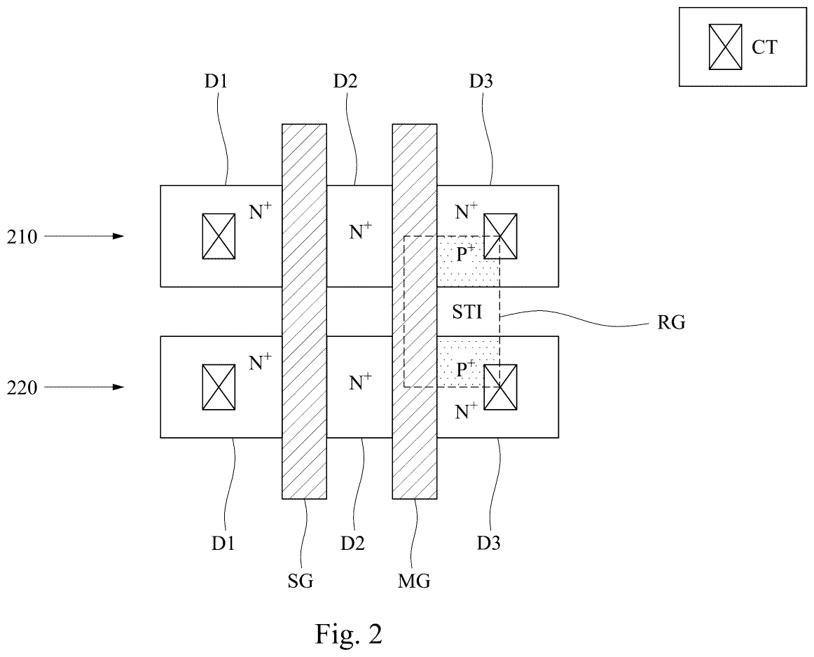

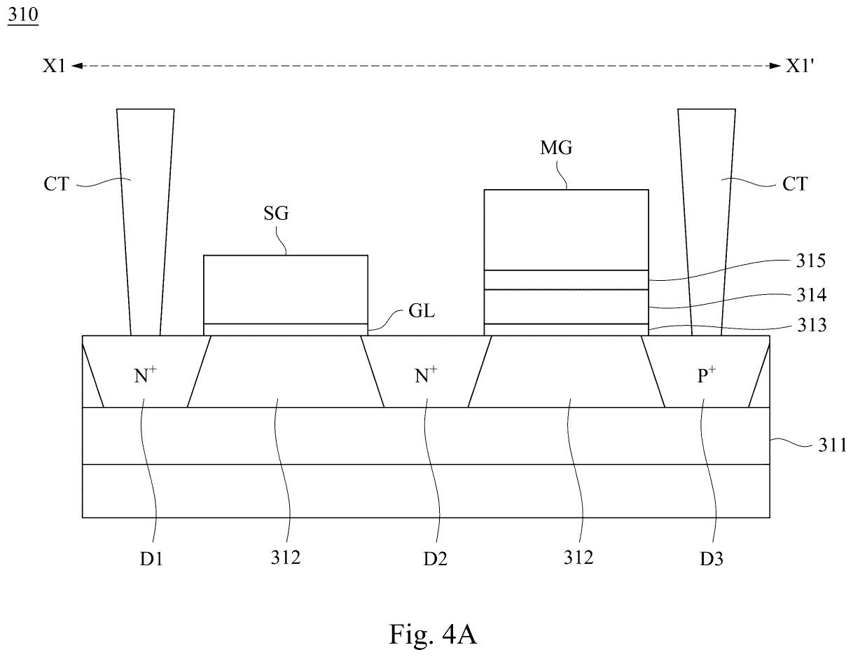

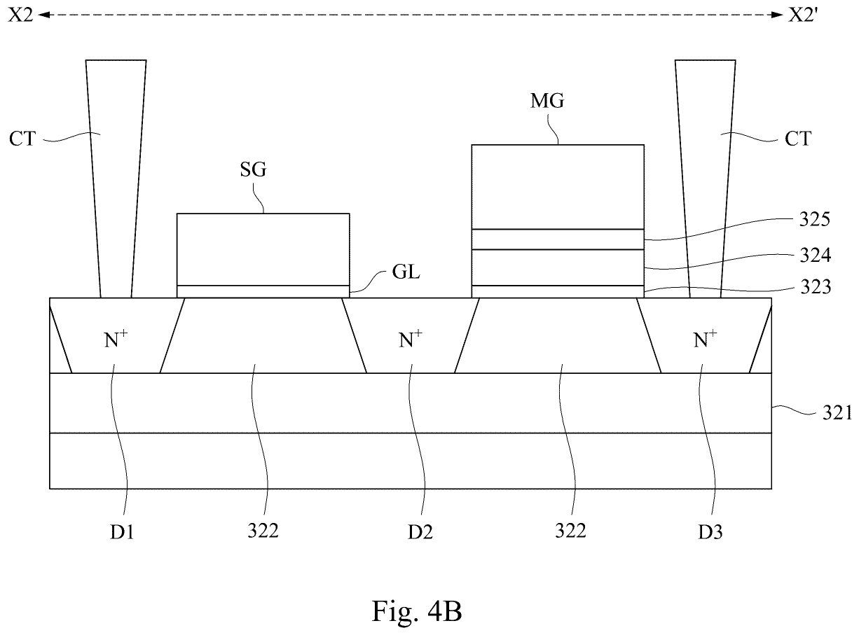

FIG. 2 is a top view of a non-volatile memory device comprising non-volatile memory cells 210 and 220 in accordance with some embodiments of the present disclosure. The non-volatile memory cells 210 and 220 of FIG. 2 are similar to the non-volatile memory cells 110 and 120 of FIG. 1, and thus the similarities will not be repeated herein. The difference between the non-volatile memory cells 210 and 220 of FIG. 2 and the non-volatile memory cells 110 and 120 of FIG. 1 is that the non-volatile memory cells 210 and 220 are formed in a silicon-on-insulator (SOI) substrate, which will be illustrated with FIGS. 4A-4B. Moreover, the doped region D3 of each of the non-volatile memory cells 210 and 220 is divided into a first portion inside a region RG and a second portion outside the region RG, wherein the first portion inside the region RG has a doped type different from that of the doped regions D1 and D2, while the second portion outside the region RG has a doped type the same as that of the doped regions D1 and D2. In addition, the first portion of the doped region D3 has the doped type the same as that of the well layer. The contact CT connected to the doped region D3 is electrically coupled to both the first portion and the second portion of the doped region D3. Consequently, the voltage on the contact CT can be transmitted to the well layer through the first portion of the doped region D3.

In some embodiments, the select gate SG is configured to receive a select voltage, the memory gate MG is configured to receive a memory voltage, and the doped regions D1 and D3 are configured to respectively receive source/drain voltages. Based on the relationship between the select voltage, the memory voltage and the source/drain voltages, the non-volatile memory device of the present disclosure can implement operations such as reverse programming and erasing operation.

The region RG corresponds to an opening on an optical mask. The opening is used to form the first portions of the adjacent memory cells 210 and 220 together after the doped regions D3 are doped with impurities of the second portions. The memory cells 210 and 220 are separated from one another by the shallow trench isolation (STI).

Take the embodiment of FIG. 2 as an example, the doped regions D1 and D2 of the non-volatile memory cells 210 and 220 have a doped type of N-type, and the well layer has a doped type of P-type. In the doped region D3, the first portion inside the region RG has a doped type of P-type, and the second portion outside the region RG has a doped type of N-type.

In some embodiments, based on the aforementioned configuration of the non-volatile memory cells 210 and 220, the contact CT as well as the first portion coupled to the contact CT together form a butted contact structure. The butted contact structure helps the charge trapping layer of the memory cell (shown in FIGS. 4A-4B) to release trapped charges, thereby improving the efficiency of the erasing operation.

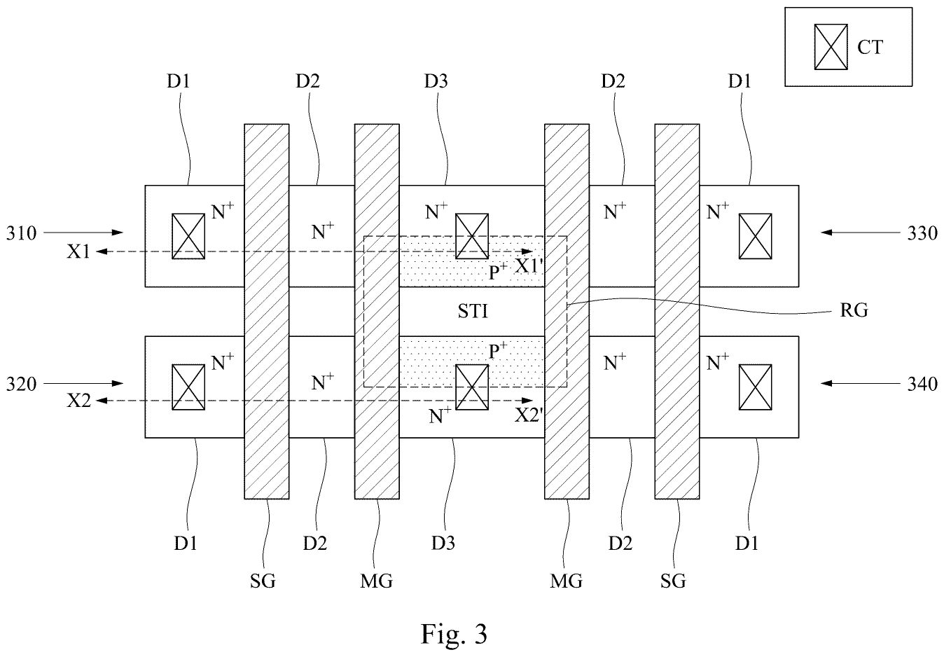

In some embodiments, two non-volatile memory cells can share the butted contact structure. Please refer to FIG. 3. FIG. 3 is a top view of a non-volatile memory device comprising non-volatile memory cells 310, 320, 330 and 340 in accordance with some embodiments of the present disclosure. The non-volatile memory cells 310, 320, 330 and 340 of FIG. 3 are similar to the non-volatile memory cells 210 and 220 of FIG. 2.

In some embodiments, the adjacent memory cells 310 and 330 share the same doped region D3 (i.e., the same first and second portions) that is coupled to a first bit line (not shown) through the contact CT. The select gates SG of the adjacent memory cells 310 and 330 are respectively coupled to first and second word lines (not shown). The memory gates MG of the adjacent memory cells 310 and 330 are respectively coupled to first and second control lines (not shown). The memory cells 320 and 340 share the same doped region D3 (i.e., the same first and second portions) that is coupled to a second bit line (not shown). The memory cells 310 and 320 share the first word line and the first control line, that is, the memory cells 310 and 320 share the select gate structure and the memory gate structure. The memory cells 330 and 340 share the second word line and the second control line, that is, the memory cells 330 and 340 share the select gate structure and the memory gate structure. In addition, the doped regions D1 of the memory cells 310, 320, 330 and 340 are coupled to the same source line (not shown).

In some embodiments, after the third doped regions D3 of the memory cells 310, 320, 330 and 340 are doped with impurities of the second portions, the first portions inside the region RG of the doped regions D3 of the memory cells 310, 320, 330 and 340 are together formed through an opening corresponding to the region RG of an optical mask.

In other embodiments, the first portions of the memory cells 310 and 320 are formed together through a first opening of the optical mask, and the first portions of the memory cells 330 and 340 are formed together through a second opening of the optical mask, according to a manner similar to that described with reference to FIG. 2. In this case, the memory cells 310, 320, 330 and 340 each have an independent first portion that is not shared with other memory cells.

FIG. 4A is a cross-sectional view of the non-volatile memory cell 310 based on the cross-section line X1-X1′ of FIG. 3. As described above, the non-volatile memory cell 310 comprises doped regions D1-D3, the memory gate structure and the select gate structure. The memory gate structure comprises a bottom dielectric layer 313, a charge trapping layer 314, a blocking layer 315, and the memory gate MG. The select gate structure comprises the select gate SG and a gate oxide layer GL. The non-volatile memory device comprises an SOI substrate, where the SOI substrate comprises a body oxide layer 311, a well layer 312 and a base layer under the body oxide layer 311. The SOI substrate may be fully or partially depleted SOI substrate. The well layer 312 is formed above the body oxide layer 311. The doped regions D1-D3 are formed within the well layer 312. The bottom dielectric layer 313 is formed above the well layer 312 and below the charge trapping layer 314. The charge trapping layer 314 is formed above the bottom dielectric layer 313 and below the blocking layer 315. The blocking layer 315 is formed above the charge trapping layer 314 and below the memory gate MG. The gate oxide layer GL is formed above the well layer 312 and below the select gate SG. The select gate SG is formed above the gate oxide layer GL. The memory gate MG is formed above the well layer 312, the bottom dielectric layer 313, the charge trapping layer 314 and the blocking layer 315. In addition, the select gate structure is located between the doped regions D1 and D2, and the memory gate structure is located between the doped regions D2 and D3.

As shown in FIG. 3, since the cross-section line X1-X1′ of FIG. 3 passes through the region RG, the doped region D3 of the non-volatile memory cell 310 is illustrated as having a doped type of P-type in FIG. 4A, that is, the P-type first portion of the doped region D3 is shown in FIG. 4A.

FIG. 4B is a cross-sectional view of the non-volatile memory cell 320 based on the cross-section line X2-X2′ of FIG. 3. The non-volatile memory cell 320 is similar to the non-volatile memory cell 310, and thus the similarities will not be repeated herein. The difference between FIG. 4B and FIG. 4A is that since the cross-section line X2-X2′ of FIG. 3 does not pass through the region RG, the doped region D3 of the non-volatile memory cell 320 is illustrated as having a doped type of N-type in FIG. 4B, that is, the N-type second portion of the doped region D3 is shown in FIG. 4B.

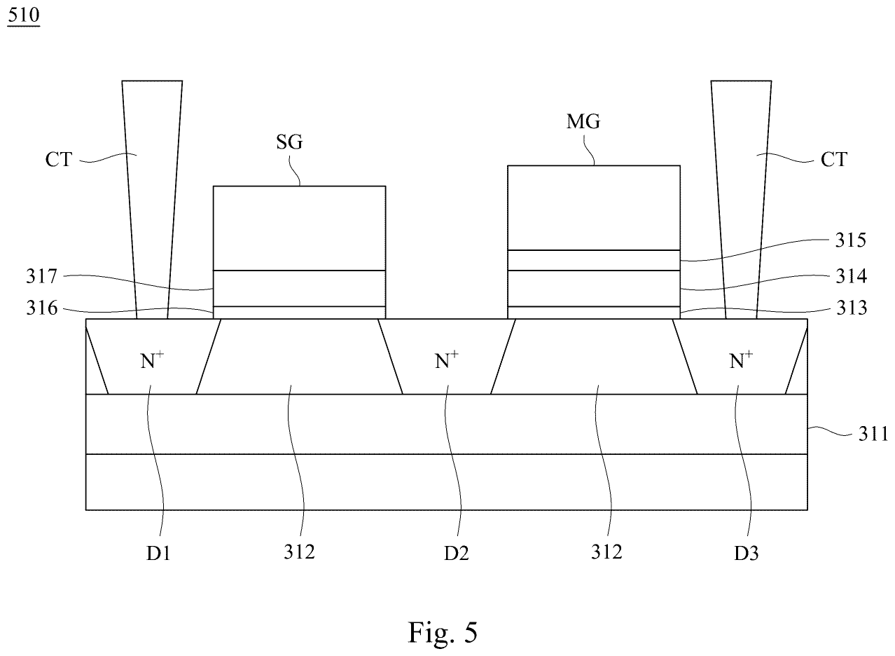

FIG. 5 is a cross-sectional view of a non-volatile memory cell 510 in accordance with some embodiments of the present disclosure. The non-volatile memory cell 510 is similar to the non-volatile memory cells 210, 220, 310, 320, 330 and 340, and applicable to form the non-volatile memory devices of FIG. 2 and FIG. 3. In the embodiment of FIG. 5, only the N-type second portion of the doped region D3 is shown and the P-type first portion is omitted for the sake of brevity. The difference between the non-volatile memory cell 510 and those of FIGS. 2-3 is that the select gate structure of the non-volatile memory cell 510 comprises the select gate SG, a bottom dielectric layer 316 and a charge trapping layer 317. The bottom dielectric layer 316 is formed above the well layer 312 and below the charge trapping layer 317. The charge trapping layer 317 is formed above the bottom dielectric layer 316 and below the select gate SG. The non-volatile memory cell 510 reduces the mask count because the select gate structure and the memory gate structure are similar in construction.

In some embodiments, the bottom dielectric layers 313, 316 and 323 and the blocking layers 315 and 325 can be composed of oxide films (e.g., silicon dioxide), and the charge trapping layers 314, 317 and 324 can be composed of silicon nitride films or silicon oxynitride films.

Although the non-volatile memory cells 210, 220, 310, 320, 330, 340 and 510 are illustrated as N-type metal oxide semiconductor (NMOS) devices in FIGS. 2-5, it should be noted that the combinations of doped types of doped regions D1-D3 of FIGS. 2-5 are only examples, and are not intended to limit the present disclosure. As long as the aforementioned conditions of the same/different doped types are met, other combinations of doped types of doped regions D1-D3 are within the scope of the present disclosure. In some embodiments, the non-volatile memory cells 210, 220, 310, 320, 330, 340 and 510 can also be implemented with P-type metal oxide semiconductor (PMOS) devices with N-type well layer 312, and their doped regions D1 and D2 have a doped type of P-type, while in their doped regions D3, the first portion inside the region RG has a doped type of N-type, and the second portion outside the region RG has a doped type of P-type.

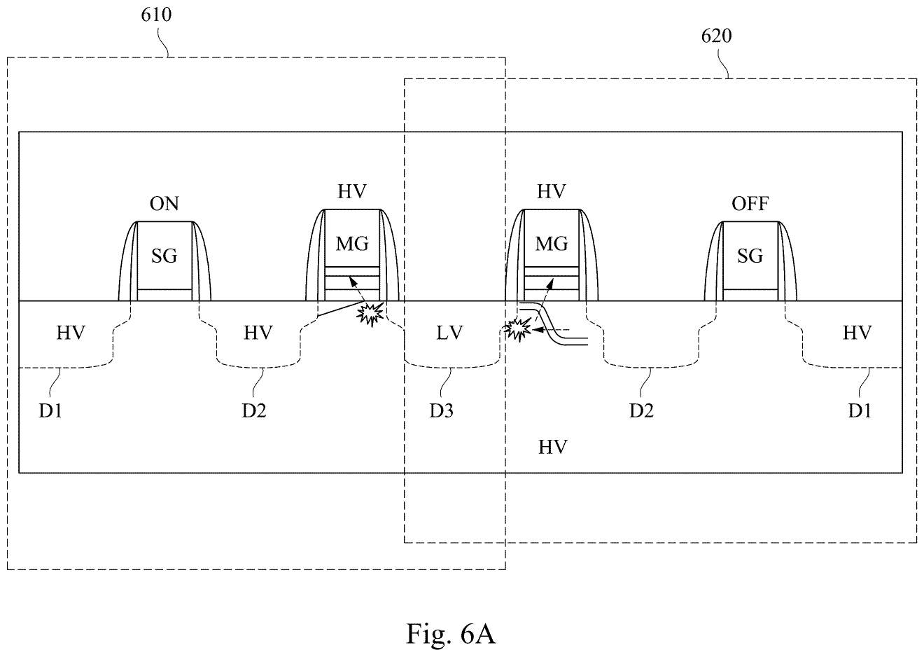

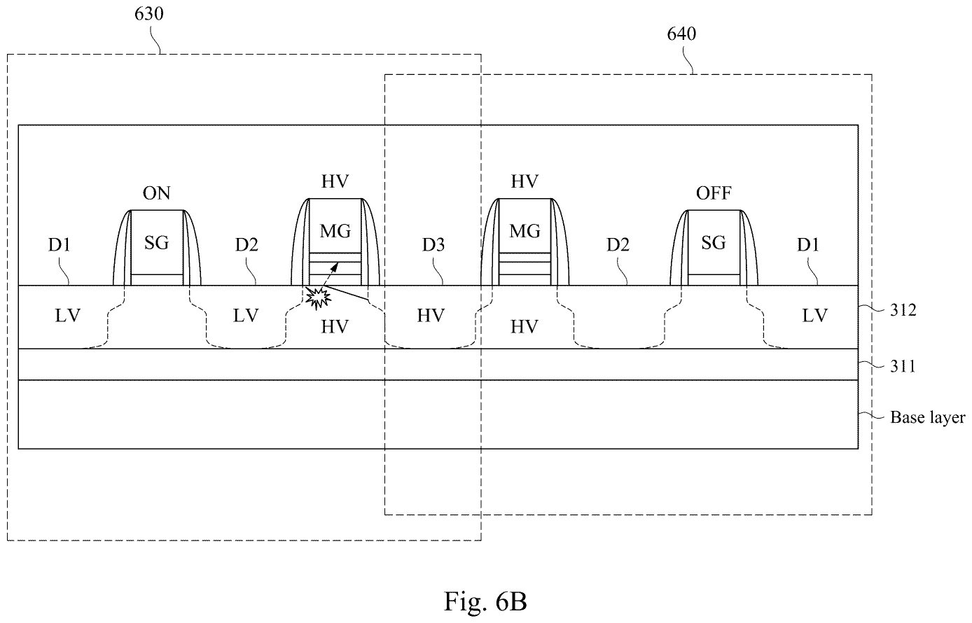

In the programming technology of non-volatile memory cells, when specific voltages are provided to the memory gate and each doped region, the programming operation can be realized. Please refer to FIG. 6A. FIG. 6A is a schematic diagram of voltage configuration of non-volatile memory cells 610 and 620 in accordance with some instances.

The non-volatile memory cells 610 and 620 in FIG. 6A are PMOS devices being forward programmed. In the configuration of FIG. 6A, a voltage HV is transmitted to the well layer, the memory gate MG of the selected non-volatile memory cell 610 (whose select gate SG is marked with “ON”) and the memory gate MG of the unselected non-volatile memory cell 620 (whose select gate SG is marked with “OFF”), and the doped region D3 shared by the two non-volatile memory cells 610 and 620 receives a voltage LV, wherein the voltage HV is significantly higher than the voltage LV. In addition, the select gate SG of the selected non-volatile memory cell 610 receives a voltage low enough to form a channel to transmit the voltage HV from the doped region D1 to the doped region D2. Consequently, the channel hot hole induced hot electron injection (CHHIHEI) effect occurs between the doped regions D2 and D3 of the selected non-volatile memory cell 610, so that the selected non-volatile memory cell 610 is programmed by hot electrons injecting into the charge trapping layer.

However, in the unselected non-volatile memory cell 620, since there are a significant voltage difference between the memory gates MG and the doped region D3 as well as a significant voltage difference between the well layer and the doped region D3, the band-to-band tunneling (BTBT) effect will occur easily and cause disturbance that electrons inject into the charge trapping layer of the unselected non-volatile memory cell 620, thereby making the memory device prone to misjudgment and affecting its performance.

FIG. 6B is a schematic diagram of voltage configuration of non-volatile memory cells 630 and 640 in accordance with some embodiments of the present disclosure. Each of the memory cells 630 and 640 can have a configuration similar to the memory cell described in FIG. 2 or FIG. 3 but is implemented as a PMOS device. The non-volatile memory cells 630 and 640 of FIG. 6B are reverse programmed. In the embodiments of FIG. 6B, the doped region D3 shared by the two non-volatile memory cells 630 and 640 receives a voltage HV, and, through the butted contact structure, the voltage HV is also transmitted to the well layer. That is, the butted contact structure facilitates the reverse programming. In addition, the memory gates MG of the selected non-volatile memory cell 630 (whose select gate SG is marked with “ON”) and the memory gates MG of the unselected non-volatile memory cell 640 (whose select gate SG is marked with “OFF”) receive the voltage HV. In other words, when the CHHIHEI effect occurs between the doped regions D2 and D3 of the selected memory cell 630, unlike FIG. 6A, since the memory gates MG of the unselected non-volatile memory cell 640 in FIG. 6B have a similar voltage to the doped region D3 and the well layer, the BTBT effect will not occur. As a result, the memory device will not be affected by disturbance, and its performance will not be affected.

In addition, since the non-volatile memory cells 630 and 640 of FIG. 6B are not affected by disturbance, the non-volatile memory cells 630 and 640 can be implemented as mirror arrangement that shares the bit line to reduce the number of control circuits, thereby reducing overall size.

The following Table 1 shows voltage configurations of the non-volatile memory cell in reverse programming in accordance with the present disclosure.

TABLE 1

| | Select | Memory | Doped | Doped | |
|---|---|---|---|---|---|
| | gate | gate | region | region | Relationship |
| | SG | MG | D1 | D3 | of voltages |
| Configuration | LV2 | HV2 | LV1 | HV1 | HV1 ≥ HV2 > |
| (1) | | | | | LV1 > LV2 |
| Configuration | HV1 | HV1 | HV2 | LV | HV1 > HV2 > |
| (2) | | | | | LV |

The configuration (1) is the configuration when the non-volatile memory cell of PMOS of the above embodiments is reverse programmed by triggering the CHHIHEI effect between the doped regions D2 and D3. In the configuration (1), the voltage that the doped region D3 receives is greater than or equal to the voltage that the memory gate MG receives, the voltage that the memory gate MG receives is greater than the voltage that the doped region D1 receives, and the voltage that the doped region D1 receives is greater than the voltage that the select gate SG receives. Accordingly, when conducting the reverse programming to the non-volatile memory cell of PMOS, the voltage received by the doped region D3 is greater than the voltage received by the doped region D1.

The configuration (2) is the configuration when the non-volatile memory cell of NMOS (e.g., the memory cells shown in FIGS. 2, 3 and 5) is reverse programmed by triggering channel hot electron injection (CHEI) effect between the doped regions D2 and D3. In the configuration (2), the voltage that the memory gate MG receives is equal to the voltage that the select gate SG receives, the voltage that the select gate SG receives is greater than the voltage that the doped region D1 receives, and the voltage that the doped region D1 receives is greater than the voltage that the doped region D3 receives. Accordingly, when conducting the reverse programming to the non-volatile memory cell of NMOS, the voltage received by the doped region D1 is greater than the voltage received by the doped region D3.

The following Table 2 shows voltage configurations of the non-volatile memory cell performing erasing operation in accordance with the present disclosure.

TABLE 2

| | Select | Memory | Doped | Doped | |
|---|---|---|---|---|---|
| | gate | gate | region | region | Relationship |
| | SG | MG | D1 | D3 | of voltages |
| Configuration | HV | −HV | floating | LV | HV > LV |
| (3) | | | | | |
| Configuration | LV1 | −HV | floating | LV2 | HV > LV1 ≥ |
| (4) | | | | | LV2 |

The configuration (3) is the configuration when the non-volatile memory cell of PMOS of the above embodiments is configured to perform an erasing operation, wherein the non-volatile memory cell is erased through channel Fowler-Nordheim (FN) tunneling effect. In the configuration (3), the doped region D1 is floating, the voltage that the select gate SG receives is greater than the voltage that the doped region D3 receives, and the voltage that the memory gate MG receives is equal to the negative value of the voltage that the select gate SG receives.

The configuration (4) is the configuration when the non-volatile memory cell of NMOS (e.g., the memory cells shown in FIGS. 2, 3 and 5) is configured to perform an erasing operation, wherein the non-volatile memory cell is erased through channel FN tunneling effect. In the configuration (4), the doped region D1 is floating, the negative value of the voltage that the memory gate MG receives is greater than the voltage that the select gate SG receives, and the voltage that the select gate SG receives is greater than or equal to the voltage that the doped region D3 receives.

Through various configurations in Table 1 and Table 2, the non-volatile memory cell in the present disclosure can reduce the disturbance caused by the BTBT effect by using reverse programming. In addition, different from the floating well of traditional SOI substrate, since the non-volatile memory cell in the present disclosure can transmit the voltage to the well layers through the first portion inside the region RG (i.e., the butted contact structure), the efficiency of erasing operation can be improved.

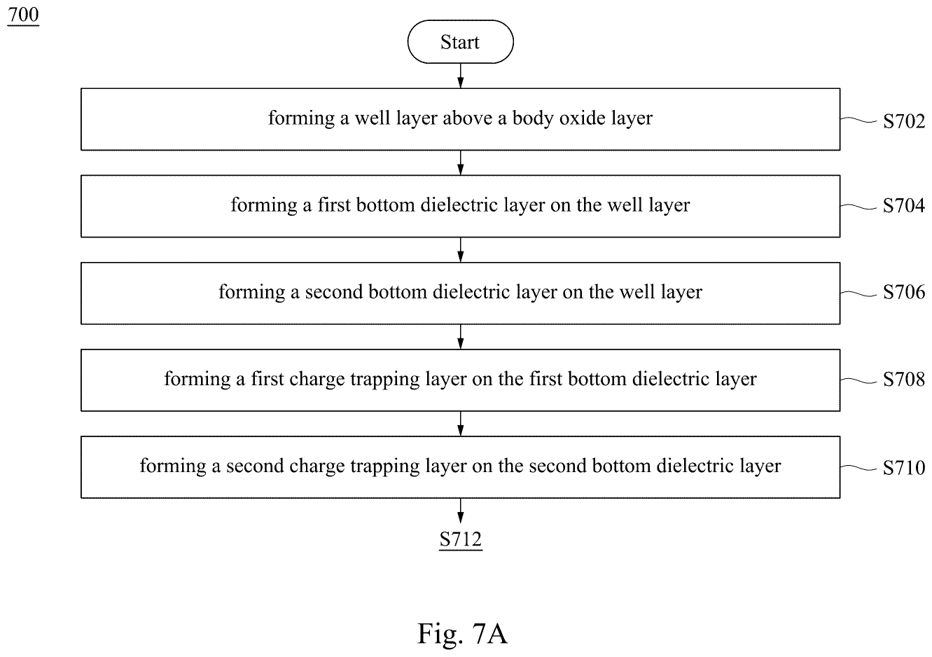

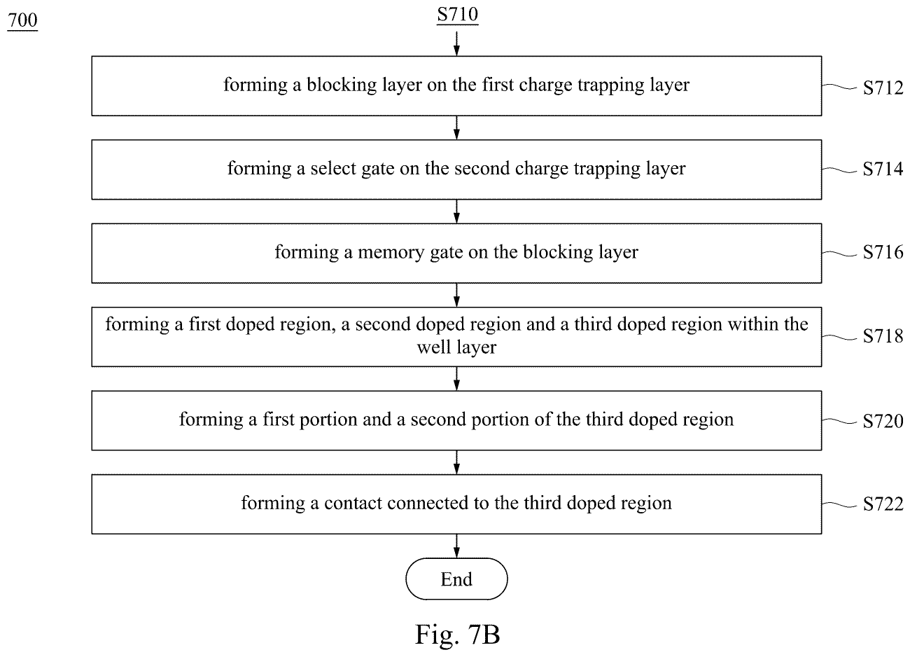

FIG. 7A and FIG. 7B jointly illustrate a flowchart of a method 700 of fabricating a non-volatile memory cell in accordance with some embodiments of the present disclosure. The method 700 is applicable to fabricate non-volatile memory cells (e.g., the non-volatile memory cells 210, 220, 310, 320, 330, 340 and 510). In some embodiments, the method 700 comprises steps S702, S704, S706, S708, S710, S712, S714, S716, S718, S720, and S722.

In step S702, a well layer (e.g., the well layer 312) is formed above a body oxide layer (e.g., the body oxide layer 311), wherein the well layer has a doped type of a first type. Next, step S704 will be performed.

In step S704, a first bottom dielectric layer (e.g., the bottom dielectric layer 313) is formed on the well layer. Next, step S706 will be performed.

In step S706, a second bottom dielectric layer (e.g., the bottom dielectric layer 316) is formed on the well layer. In some embodiments, step S704 and step S706 may be performed simultaneously. Next, step S708 will be performed.

In step S708, a first charge trapping layer (e.g., the charge trapping layer 314) is formed on the first bottom dielectric layer. Next, step S710 will be performed.

In step S710, a second charge trapping layer (e.g., the charge trapping layer 317) is formed on the second bottom dielectric layer. In some embodiments, step S708 and step S710 may be performed simultaneously. Next, step S712 will be performed.

In step S712, a blocking layer (e.g., the blocking layer 315) is formed on the first charge trapping layer. Next, step S714 will be performed.

In step S714, a select gate (e.g., the select gate SG) is formed on the second charge trapping layer. Next, step S716 will be performed.

In step S716, a memory gate (e.g., the memory gate MG) is formed on the blocking layer. In some embodiments, step S714 and step S716 may be performed simultaneously. Next, step S718 will be performed.

Accordingly, steps S704, S708, S712 and S716 are for forming a memory gate structure above the well layer, where the memory gate structure comprises the first bottom dielectric layer, the first charge trapping layer, the blocking layer and the memory gate. Steps S706, S710 and S714 are for forming a select gate structure above the well layer, where the select gate structure comprises the second bottom dielectric layer, the second charge trapping layer and the select gate.

In step S718, a first doped region, a second doped region and a third doped region (e.g., the doped regions D1-D3) are formed within the well layer, wherein the select gate structure is located between the first doped region and the second doped region, and the memory gate structure is located between the second doped region and the third doped region. Next, step S720 will be performed.

In step S720, a first portion and a second portion of the third doped region are formed, wherein the first portion of the third doped region has a doped type of the first type, and the first doped region, the second doped region and the second portion of the third doped region have a doped type of a second type, wherein the first type is different from the second type. Next, step S722 will be performed.

In step S722, a contact (e.g., the contact CT) connected to the third doped region is formed, wherein the contact is electrically coupled to both the first portion and the second portion.

It should be noted that the number and order of steps of the forming, programming method 700 of the present disclosure are only examples, and are not intended to limit the present disclosure. Other numbers and orders of steps are within the scope of the present disclosure.

Through the non-volatile memory cells and the method of the present disclosure, not only the efficiency of erasing operations can be enhanced, but the impact of the BTBT effect can also be alleviated and the size of memory devices can also be reduced, thereby improving the accuracy of memory device operation.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A non-volatile memory device comprising a plurality of non-volatile memory cells, a body oxide layer and a well layer, wherein the well layer is above the body oxide layer and has a doped type of a first type, wherein each of the non-volatile memory cells comprises:
a first doped region;
a second doped region;
a third doped region, comprising a first portion and a second portion, wherein the first doped region, the second doped region and the third doped region are formed within the well layer;
a select gate structure, formed above the well layer and located between the first doped region and the second doped region; and
a memory gate structure, formed above the well layer and located between the second doped region and the third doped region,
wherein the first portion of the third doped region has a doped type of the first type, and the first doped region, the second doped region and the second portion of the third doped region have a doped type of a second type, wherein the first type is different from the second type.

2. The non-volatile memory device of claim 1, wherein the memory gate structure comprises:
a first bottom dielectric layer, formed on the well layer;
a first charge trapping layer, formed on the first bottom dielectric layer;
a blocking layer, formed on the first charge trapping layer; and
a memory gate, formed on the blocking layer.

3. The non-volatile memory device of claim 2, wherein the select gate structure comprises:
a second bottom dielectric layer, formed on the well layer;
a second charge trapping layer, formed on the second bottom dielectric layer; and
a select gate, formed on the second charge trapping layer.

4. The non-volatile memory device of claim 1, wherein in response to the non-volatile memory device performing an erasing operation, a select gate of the select gate structure is configured to receive a select voltage, a memory gate of the memory gate structure is configured to receive a memory voltage, the first doped region is floating, and the third doped region is configured to receive a first source/drain voltage, and
wherein the select voltage is greater than the first source/drain voltage, and the memory voltage is equal to a negative value of the select voltage.

5. The non-volatile memory device of claim 1, wherein in response to the non-volatile memory device performing an erasing operation, a select gate of the select gate structure is configured to receive a select voltage, a memory gate of the memory gate structure is configured to receive a memory voltage, the first doped region is floating, and the third doped region is configured to receive a first source/drain voltage, and
wherein the select voltage is greater than or equal to the first source/drain voltage, and a negative value of the memory voltage is greater than the select voltage.

6. The non-volatile memory device of claim 1, wherein in response to the non-volatile memory device performing a reverse programming operation, a select gate of the select gate structure is configured to receive a select voltage, a memory gate of the memory gate structure is configured to receive a memory voltage, the third doped region is configured to receive a first source/drain voltage, and the first doped region is configured to receive a second source/drain voltage, and
wherein the first source/drain voltage is greater than or equal to the memory voltage, the memory voltage is greater than the second source/drain voltage, and the second source/drain voltage is greater than the select voltage.

7. The non-volatile memory device of claim 1, wherein in response to the non-volatile memory device performing a reverse programming operation, a select gate of the select gate structure is configured to receive a select voltage, a memory gate of the memory gate structure is configured to receive a memory voltage, the third doped region is configured to receive a first source/drain voltage, and the first doped region is configured to receive a second source/drain voltage, and
wherein the memory voltage is equal to the select voltage, the select voltage is greater than the second source/drain voltage, and the second source/drain voltage is greater than the first source/drain voltage.

8. The non-volatile memory device of claim 1, wherein each of the plurality of non-volatile memory cells further comprises a contact connected to the third doped region, wherein the contact is electrically coupled to both the first portion and the second portion.

9. The non-volatile memory device of claim 1, wherein a first memory cell of the plurality of non-volatile memory cells shares with an adjacent second memory cell of the plurality of non-volatile memory cells the third doped region,
wherein the first memory cell shares with an adjacent third memory cell of the plurality of non-volatile memory cells the select gate structure and the memory gate structure, and
wherein the first portion of the first memory cell, the first portion of the second memory cell and the first portion of the third memory cell are concurrently formed through an opening of an optical mask.

10. The non-volatile memory device of claim 1, wherein a first memory cell of the plurality of non-volatile memory cells shares with an adjacent second memory cell of the plurality of non-volatile memory cells the select gate structure and the memory gate structure,
wherein the first portion of the first memory cell and the first portion of the second memory cell are concurrently formed through an opening of an optical mask.

11. A method of fabricating each memory cell of a plurality of non-volatile memory cells of a non-volatile memory device, comprising:
forming a well layer above a body oxide layer, wherein the well layer has a doped type of a first type;
forming a select gate structure above the well layer;
forming a memory gate structure above the well layer;
forming a first doped region, a second doped region and a third doped region within the well layer, wherein the select gate structure is located between the first doped region and the second doped region, and the memory gate structure is located between the second doped region and the third doped region; and
forming a first portion and a second portion of the third doped region, wherein the first portion of the third doped region has a doped type of the first type, and the first doped region, the second doped region and the second portion of the third doped region have a doped type of a second type, wherein the first type is different from the second type.

12. The method of claim 11, wherein forming the memory gate structure comprises:
forming a first bottom dielectric layer on the well layer;
forming a first charge trapping layer on the first bottom dielectric layer;
forming a blocking layer on the first charge trapping layer; and
forming a memory gate on the blocking layer.

13. The method of claim 12, wherein forming the select gate structure comprises:
forming a second bottom dielectric layer on the well layer;
forming a second charge trapping layer on the second bottom dielectric layer; and
forming a select gate on the second charge trapping layer.

14. The method of claim 11, further comprising:
forming a contact connected to the third doped region, wherein the contact is electrically coupled to both the first portion and the second portion.

15. The method of claim 11, wherein a first memory cell of the plurality of non-volatile memory cells shares with an adjacent second memory cell of the plurality of non-volatile memory cells the third doped region, and the first memory cell shares with an adjacent third memory cell of the plurality of non-volatile memory cells the select gate structure and the memory gate structure, wherein forming the first portion and the second portion of the third doped region comprises:
forming the first portion of the first memory cell, the first portion of the second memory cell and the first portion of the third memory cell concurrently through an opening of an optical mask.

16. The method of claim 11, wherein a first memory cell of the plurality of non-volatile memory cells shares with an adjacent second memory cell of the plurality of non-volatile memory cells the select gate structure and the memory gate structure, wherein forming the first portion and the second portion of the third doped region comprises:
forming the first portion of the first memory cell and the first portion of the second memory cell concurrently through an opening of an optical mask.
